(19) United States
(12) Patent Application Publication
(10) Pub. No.: US 2025/0391331 A1
(43) Pub. Date: Dec. 25, 2025

(54) PIXEL AND DISPLAY DEVICE INCLUDING THE SAME, AND ELECTRONIC DEVICE

(71) Applicant: Samsung Display Co., Ltd., Yongin-si (KR)

(72) Inventors: Ki Hyun PYO, Yongin-si (KR); Se Hyun LEE, Yongin-si (KR); Yeon Kyung KIM, Yongin-si (KR)

(21) Appl. No.: 19/096,540

(22) Filed: Mar. 31, 2025

(30) Foreign Application Priority Data
Jun. 24, 2024 (KR) 10-2024-0081973

(51) Int. Cl. G09G 3/32; G09G 3/3233

(52) U.S. Cl. CPC G09G 3/32; G09G 3/3233; G09G 2300/0819; G09G 2300/0852; G09G 2300/0861; G09G 2310/08; G09G 2320/0238

(57) ABSTRACT

A pixel includes: a first power line configured to receive a first initialization power supply voltage configured to swing between a first voltage and a second voltage; a light-emitting element; a first circuit configured to control a supply period of a driving current in response to a data signal supplied from a data line; and a second circuit configured to supply the driving current corresponding to a difference voltage of the first voltage and the second voltage to the light-emitting element.

### CROSS-REFERENCE TO RELATED PATENT APPLICATION

The present application claims priority under 35 U.S.C. § 119(a) to Korean patent application number 10-2024-0081973 filed on Jun. 24, 2024, in the Korean Intellectual Property Office, the entire disclosure of which is incorporated by reference herein.

### BACKGROUND OF THE INVENTION

### 1. Field

Aspects of some embodiments of the present disclosure relate to a pixel and a display apparatus including the same, and electronic device.

### 2. Description of the Related Art

With development of information technology, the importance of display devices, which provide a connection medium between users and information, is being highlighted. In response, the use of display devices such as liquid crystal display devices and organic light emitting display devices is increasing.

Recently, display devices with high-resolution panels have been applied to various fields and applications, and as a result, pixels which are applicable to high-resolution panels may be desirable.

The above information disclosed in this Background section is only for enhancement of understanding of the background and therefore the information discussed in this Background section does not necessarily constitute prior art.

### SUMMARY OF THE INVENTION

Aspects of some embodiments of the present disclosure include a pixel applicable to a high-resolution panel and a display device including the same.

A pixel according to some embodiments of the present disclosure includes: a first power line which is supplied with a first initialization power supply voltage swinging between a first voltage and a second voltage; a light-emitting element; a first circuit which controls a supply period of a driving current in response to a data signal supplied from a data line; and a second circuit for supplying the driving current corresponding to a difference voltage of the first voltage and the second voltage to the light-emitting element.

According to some embodiments, the data signal may have different voltages corresponding to different gradations.

According to some embodiments, the first circuit and the second circuit may be electrically connected by a common node, and the first circuit may control the supply period of the driving current while controlling a voltage supplied to the common node in correspondence to the data signal.

According to some embodiments, the first circuit may include a first transistor having a gate electrode connected to a first node, a first electrode connected to a second node, and a second electrode connected to a third node; a second transistor which is connected between the data line and the second node and having a gate electrode connected to a scanning line; a third transistor which is connected between the first node and the third node and having a gate electrode connected to the scanning line; a fourth transistor which is connected between the first node and the first power line and having a gate electrode connected to a first initialization line; and a first capacitor connected between a sweep line and the first node.

According to some embodiments, the first circuit may further include a fifth transistor which is connected between a second power line to which a first power supply voltage is input and the second node and having a gate electrode connected to a light-emitting control line; and a sixth transistor which is connected between the third node and a fourth node and having a gate electrode connected to the light-emitting control line.

According to some embodiments, the first transistor, the fifth transistor, and the sixth transistor may be P-type transistors, and the second transistor, the third transistor, and the fourth transistor may be N-type transistors.

According to some embodiments, the second circuit may include a second capacitor connected between the fourth node and a fifth node; a seventh transistor having a first electrode connected to a third power line to which a second power supply voltage is input, a second electrode connected to a sixth node, and a gate electrode connected to the fifth node; an eighth transistor which is connected between the fifth node and the sixth node and having a gate electrode connected to a compensation line; a ninth transistor which is connected between the fourth node and the first power line and having a gate electrode connected to a second initialization line; a tenth transistor which is connected between the sixth node and a first electrode of the light-emitting element and having a gate electrode connected to the light-emitting control line; and an eleventh transistor which is connected between the fifth node and a fifth power line to which a second initialization power supply voltage is supplied and having a gate electrode connected to a third initialization line, and the second power supply voltage may have a different voltage from the first power supply voltage.

According to some embodiments, the seventh transistor and the tenth transistor may be P-type transistors, and the eighth transistor, the ninth transistor, and the eleventh transistor may be N-type transistors.

According to some embodiments, a second electrode of the light-emitting element may be connected to a fourth power line to which a third power supply voltage is input, and the third power supply voltage may have a lower voltage than the second power supply voltage.

According to some embodiments, the pixel may further include a twelfth transistor which is connected between the first electrode of the light-emitting element and a sixth power line to which a third initialization power supply voltage is input and having a gate electrode connected to the control line, and the twelfth transistor may be a P-type transistor.

According to some embodiments, the pixel may further include a twelfth transistor which is connected between the first electrode of the light-emitting element and a sixth power line to which a third initialization power supply voltage is input and having a gate electrode connected to the light-emitting control line, and the twelfth transistor may be an N-type transistor.

According to some embodiments, the pixel may further include a third capacitor connected between the third power line and the fifth node.

A display device according to some embodiments of the present disclosure includes: a first power line which is supplied with a first initialization power supply voltage swinging between a first voltage and a second voltage; and pixels connected to any one of scanning lines, any one of data lines, a first initialization line, a second initialization line, a third initialization line, a light-emitting control line, a compensation line, and a sweep line; wherein each of the pixels includes: a light-emitting element; a first circuit which controls a supply period of a driving current in response to a data signal supplied from the data line connected to the pixel; and a second circuit for supplying the driving current corresponding to a difference voltage of the first voltage and the second voltage to the light-emitting element.

According to some embodiments, the pixels may be further connected to a second power line supplied with a first power supply voltage; a third power line supplied with a second power supply voltage having a different voltage from the first power supply voltage; a fourth power line supplied with a third power supply voltage having a lower voltage than the second power supply voltage; a fifth power line supplied with a second initialization power supply voltage; and a sixth power line supplied with a third initialization power supply voltage.

According to some embodiments, the first circuit may include a first transistor having a gate electrode connected to a first node, a first electrode connected to a second node, and a second electrode connected to a third node; a second transistor which is connected between the data line and the second node and having a gate electrode connected to a scanning line; a third transistor which is connected between the first node and the third node and having a gate electrode connected to the scanning line; a fourth transistor which is connected between the first node and the first power line and having a gate electrode connected to the first initialization line; a first capacitor connected between the sweep line and the first node; a fifth transistor which is connected between the second power line and the second node and having a gate electrode connected to the light-emitting control line; and a sixth transistor which is connected between the third node and a fourth node and having a gate electrode connected to the light-emitting control line.

According to some embodiments, the second circuit may include a second capacitor connected between the fourth node and a fifth node; a seventh transistor having a first electrode connected to the third power line, a second electrode connected to a sixth node, and a gate electrode connected to the fifth node; an eighth transistor which is connected between the fifth node and the sixth node and having a gate electrode connected to the compensation line; a ninth transistor which is connected between the fourth node and the first power line and having a gate electrode connected to the second initialization line; a tenth transistor which is connected between the sixth node and a first electrode of the light-emitting element and having a gate electrode connected to the light-emitting control line; and an eleventh transistor which is connected between the fifth node and the fifth power line and having a gate electrode connected to the third initialization line.

According to some embodiments, the first transistor, the fifth transistor, the sixth transistor, the seventh transistor, and the tenth transistor may be P-type transistors, and the second transistor, the third transistor, the fourth transistor, the eighth transistor, the ninth transistor, and the eleventh transistor may be N-type transistors.

According to some embodiments, the pixel may further include a twelfth transistor which is connected between the first electrode of the light-emitting element and the sixth power line to which the third initialization power supply voltage is input and having a gate electrode connected to the light-emitting control line or a control line which is supplied with a control signal whose phase is inverted from that of a light-emitting control signal supplied to the light-emitting control line.

According to some embodiments, one frame period may include a first section, a second section, a third section, a fourth section, and a fifth section, the display device may further include a scanning driver for sequentially supplying an enable scanning signal to the scanning lines during the second section; a data driver for supplying the data signal to the data lines during the second section; a common driver for supplying an enable first initialization signal to the first initialization line during the first section, an enable second initialization signal to the second initialization line during the third section and the fourth section, an enable third initialization signal to the third initialization line during the third section, an enable light-emitting control signal to the light-emitting control line during the fifth section, an enable compensation signal to the compensation line during a first sub-section which is a part of the fourth section, and the first initialization power supply voltage having the second voltage during the third section and the first sub-section and the first voltage during the other periods to the first power line; and a sweep driver for supplying a sweep signal whose voltage is gradually lowered from a reference voltage to the sweep line during the fifth section.

According to some embodiments, the third section and the fourth section may overlap with the second section.

An electronic device according to some embodiments of the present disclosure includes: a processor to provide image data signal; and a display device to display an image based on the image data signal. The display device includes: a first power line which is supplied with a first initialization power supply voltage swinging between a first voltage and a second voltage; and pixels connected to any one of scanning lines, any one of data lines, a first initialization line, a second initialization line, a third initialization line, a light-emitting control line, a compensation line, and a sweep line; wherein each of the pixels includes: a light-emitting element; a first circuit which controls a supply period of a driving current in response to a data signal supplied from the data line connected to the pixel; and a second circuit for supplying the driving current corresponding to a difference voltage of the first voltage and the second voltage to the light-emitting element.

Aspects of some embodiments of the present disclosure are not limited to the characteristics mentioned above, and other characteristics not mentioned may be more clearly understood by a person skilled in the art from the following description.

In a pixel according to some embodiments of the present disclosure and a display device including the same, it may be possible to implement gradations using light-emitting time. When the gradations are implemented using the light-emitting time, the wavelength may not be shifted by a current density (an amount of current), and display quality may be relatively improved accordingly.

However, aspects of embodiments according to the present disclosure are not limited to the characteristics described above, and may be expanded in various ways within the scope of embodiments according to the present disclosure.

### BRIEF DESCRIPTION OF THE DRAWINGS

FIG. 1 is a drawing illustrating a display device according to some embodiments of the present disclosure.

FIG. 2 is a drawing illustrating a display device according to some embodiments of the present disclosure.

FIG. 3 is a drawing illustrating a pixel according to some embodiments of the present disclosure.

FIG. 4 is a waveform diagram illustrating aspects of a method of driving the pixel shown in FIG. 3 according to some embodiments.

FIGS. 5A to 5E are drawings illustrating aspects of an operation process of the pixel in correspondence to the waveform diagram of FIG. 4 according to some embodiments.

FIG. 6 is a waveform diagram illustrating aspects of a method of driving the pixel shown in FIG. 3 according to some embodiments.

FIG. 7 is a drawing illustrating aspects of a pixel according to some embodiments of the present disclosure.

FIG. 8 is a drawing illustrating aspects of a pixel according to some embodiments of the present disclosure.

FIGS. 9 to 12 are perspective views illustrating application examples of a display device according to some embodiments of the present disclosure.

FIG. 13 is a block diagram of an electronic device according to an embodiment.

FIG. 14 shows schematic views of various embodiments of an electronic device.

### DETAILED DESCRIPTION

Hereinafter, referring to the accompanying drawings, various embodiments of the present disclosure are described in more detail so that those skilled in the art to which the present invention pertains can easily practice them. The present invention may be implemented in many different forms and is not limited to the embodiments described herein.

In order to clearly explain the present invention, parts irrelevant to the description are omitted, and the same reference numerals are given for the same or similar components throughout the specification. Therefore, reference numerals mentioned previously may be used in other drawings as well.

Further, the expression “the same” in the description may mean “substantially the same”. In other words, this expression may indicate that two parts are so identical that a person skilled in the art would be convinced that they are identical. Other expressions may also be expressions from which the word “substantially” is omitted.

Some embodiments are described in the accompanying drawings in relation to functional blocks, units, and/or modules. A person skilled in the art will understand that these blocks, units, and/or modules are physically implemented by logic circuits, individual components, microprocessors, hardwire circuits, memory devices, wiring connections, and other electronic circuits. These may be formed using semiconductor-based manufacturing technologies or other manufacturing technologies. In the case of blocks, units, and/or modules implemented by a microprocessor or other similar hardware, they may be programmed and controlled using software to perform various functions discussed herein, and may optionally be driven by firmware and/or software. Further, each block, unit, and/or module may be implemented by dedicated hardware, or it may be implemented as a combination of dedicated hardware that performs some functions and a processor that performs other functions (e.g., one or more programmed microprocessors and associated circuitry). Furthermore, in some embodiments, blocks, units, and/or modules may be physically separated into two or more individual blocks, units, and/or modules interacting without departing from the scope of the present disclosure. In addition, in some embodiments, blocks, units, and/or modules may be combined into physically more complex blocks, units, and/or modules without departing from the scope of the present disclosure.

The term “connection” between two components may be used to encompass, but is not necessarily limited to, both electrical and physical connections. For example, the term “connection” used in reference to a circuit diagram may refer to an electrical connection, while the term “connection” used in reference to a cross-sectional or plan view may refer to a physical connection.

Although the terms such as first and second are used to describe various components, these components are not limited by these terms. These terms are merely used to distinguish one component from another. Accordingly, it should be noted that a first component mentioned below may also be a second component within the technical idea of the present invention.

The present invention is not limited to embodiments disclosed below, and may be modified and practiced in various forms. Further, each of the embodiments disclosed below may be implemented alone or in combination with at least one other embodiment.

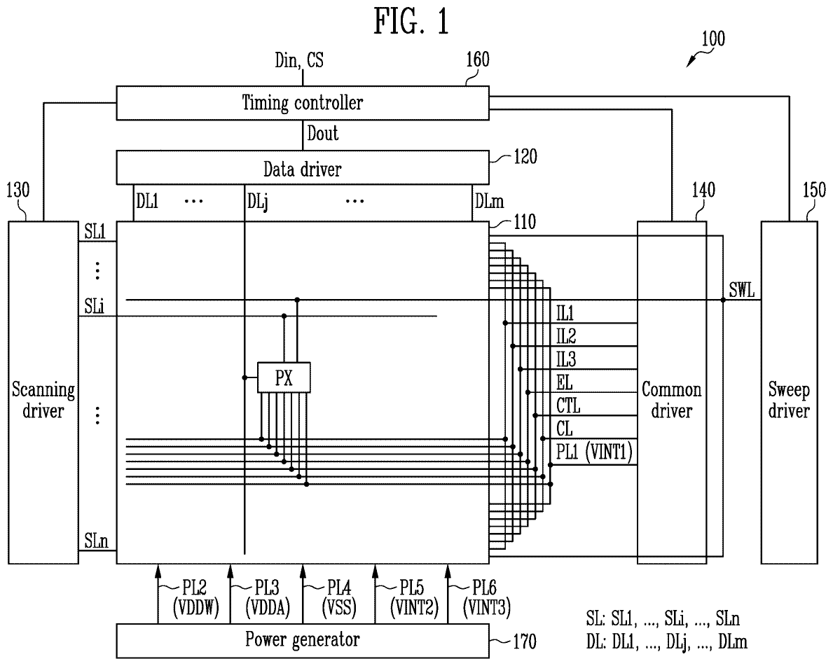

FIG. 1 is a drawing illustrating a display device according to some embodiments of the present disclosure.

Referring to FIG. 1, a display device 100 according to some embodiments of the present disclosure may include a display 110 (or a display panel), a data driver 120, a scanning driver 130, a common driver 140, a sweep driver 150, a timing controller 160, and a power generator 170.

Each of the data driver 120, the scanning driver 130, the common driver 140, the sweep driver 150, the timing controller 160, and the power generator 170 may include one integrated chip (IC), or two or more drivers (at least two of 120, 130, 140, 150, 160, and 170) may be configured by a single IC. In addition, some of the drivers (120, 130, 140, 150, 160, and 170) may not be configured by chips, but may be formed on a panel in the same way as pixels (PXs) (or sub-pixels). For example, at least one of the scanning driver 130, the common driver 140, or the sweep driver 150 may be formed on the panel.

The display 110 may include a plurality of pixels (PXs). Although FIG. 1 illustrates a single pixel PX, as a person having ordinary skill in the art would appreciate, the display 110 may include any suitable number of pixels PX according to the design and size of the display 110. Each of the pixel (PXs) may be connected to any one of scanning lines (any one of SL1, . . . , SLi, . . . , SLn) (n is a natural number of 3 or more), any one of data lines (any one of DL1, . . . , DLj, . . . , DLm) (m is a natural number of 3 or more), a first initialization line (IL1), a second initialization line (IL2), a third initialization line (IL3), a light-emitting control line (EL), a control line (CTL), and a compensation line (CL). Further, each of the pixels (PXs) may be connected to a first power line (PL1), a second power line (PL2), a third power line (PL3), a fourth power line (PL4), a fifth power line (PL5), and a sixth power line (PL6).

For example, a pixel (PX) located on an i-th horizontal line (e.g., pixels (PXs) connected to the same scanning line may be classified as a horizontal line) and a j-th vertical line (e.g., pixels (PXs) connected to the same data line may be classified as a vertical line) may be connected to the i-th scanning line (SLi), the j-th data line (DLj), the first initialization line (IL1), the second initialization line (IL2), the third initialization line (IL3), the light-emitting control line (EL), the control line (CTL), and the compensation line (CL). The first initialization line (IL1), the second initialization line (IL2), the third initialization line (IL3), the light-emitting control line (EL), the control line (CTL), and the compensation line (CL) may be commonly connected to the pixels (PXs).

The pixels (PXs) may be selected when a scanning signal is supplied to the scanning line (SL) to which they are connected, so that a data signal may be supplied from the data line (DL) to which they are connected. The pixels (PXs) which is supplied with the data signal may emit light of a brightness (e.g., a set or predetermined brightness) during a light-emitting time corresponding to the data signal.

The timing controller 160 may receive an input data (Din) and a control signal (CS) from a processor. The processor may be an application processor, a central processing unit (CPU), a graphics processing unit (GPU), and the like.

The timing controller 160 may generate output data (Dout) by correcting the input data (Din). For example, the timing controller 160 may generate the output data (Dout) by correcting the input data (Din) in response to the temperature of the display 110, an optical measurement result (measured during operation), a dimming level, and the like. Further, the timing controller 160 may generate driving signals to control the drivers (120, 130, 140, 150, and 170) in correspondence to the control signal (CS) and supply the driving signals to the respective drivers (120, 130, 140, 150, 160, and 170).

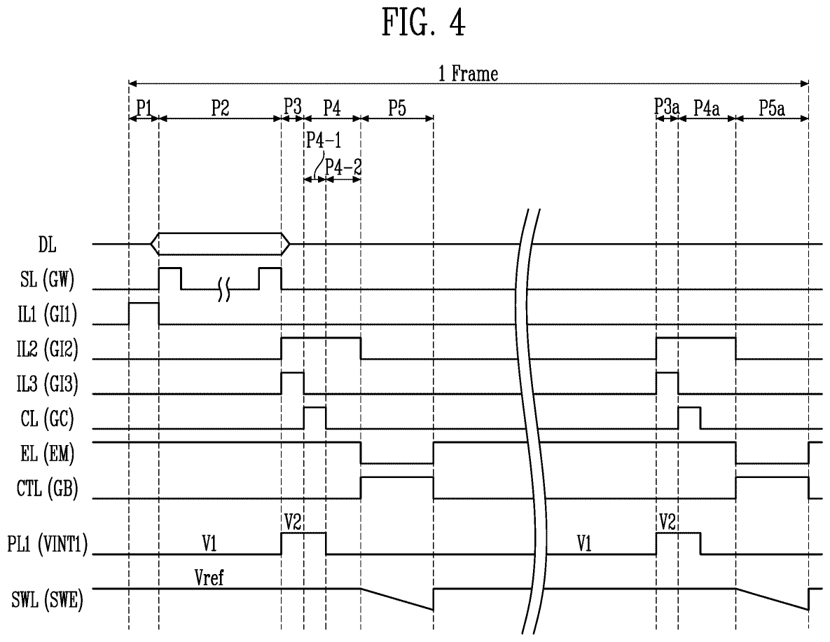

The data driver 120 may generate a data signal with a voltage (e.g., a set or predetermined voltage) using the output data (Dout) and supply the data signal to the data lines (DLs). For example, the data driver 120 may supply the data signal to the data lines (DLs) during a second section (P2) of one frame period (1 Frame) as shown in FIG. 4. The voltage of the data signal may be set to correspond to a gradation of the output data (Dout). The pixels (PXs) may emit light for a period of time corresponding to the voltage of the data signal.

The scanning driver 130 may supply the scanning signal to the scanning lines (SLs) formed in each horizontal line. For example, the scanning driver 130 may sequentially supply an enable scanning signal (GW) to the scanning lines (SLs) during the second section (P2) as shown in FIG. 4. The pixels (PXs) may then be selected sequentially in horizontal line units to receive the data signal.

The enable scanning signal (GW) may have a gate-on voltage, and a transistor supplied with the enable scanning signal (GW) may be turned on. For example, if the transistor is a P-type transistor, the enable scanning signal (GW) may have a logic low voltage. For example, if the transistor is an N-type transistor, the enable scanning signal (GW) may have a logic high voltage.

During a period for which the enable scanning signal (GW) is not supplied to the scanning lines (SLs), the scanning lines (SLs) may be supplied with a disable scanning signal (GW). The disable scanning signal (GW) may have a gate-off voltage, and a transistor supplied with the disable scanning signal (GW) may be turned off accordingly.

The common driver 140 may supply an enable first initialization signal to the first initialization line (IL1), an enable second initialization signal to the second initialization line (IL2), an enable third initialization signal to the third initialization line (IL3), a light-emitting control signal to the light-emitting control line (EL), a control signal to the control line (CTL), a compensation signal to the compensation line (CL), and a voltage of a first initialization power supply voltage (VINT1) to the first power line (PL1).

According to some embodiments, the common driver 140 may supply an enable first initialization signal (GI1) to the first initialization line (IL1) during the first section P1 as shown in FIG. 4. The enable first initialization signal (GI1) may have a gate-on voltage (e.g., logic high voltage) to allow a transistor to turn on.

According to some embodiments, the common driver 140 may supply an enable second initialization signal (GI2) to the second initialization line (IL2) during a third section (P3, P3a) and a fourth section (P4, P4a) as shown in FIG. 4. The enable second initialization signal (GI2) may have a gate-on voltage (e.g., a logic high voltage) to allow a transistor to turn on.

According to some embodiments, the common driver 140 may supply an enable third initialization signal (GI3) to the third initialization line (IL3) during the third section (P3, P3a) as shown in FIG. 4. The enable third initialization signal (GI3) may have a gate-on voltage (e.g., a logic high voltage) to allow a transistor to turn on.

According to some embodiments, the common driver 140 may supply a disable light-emitting control signal (EM) to the light-emitting control line (EL) during the first section P1, the second section P2, the third section (P3, P3a), and the fourth section (P4, P4a), as shown in FIG. 4. The common driver 140 may supply an enable light-emitting control signal (EM) to the light-emitting control line (EL) during a fifth section (P5, P5a). The disable light-emitting control signal (EM) may have a gate-off voltage (e.g., a logic high-voltage), and the enable light-emitting control signal (EM) may have a gate-on voltage (e.g., a logic low voltage).

According to some embodiments, the common driver 140 may supply a disable control signal (GB) to the control line (CTL) during the fifth section (P5, P5a), as shown in FIG. 4. The common driver 140 may supply an enable control signal (GB) to the control line (CTL) during the first section (P1), the second section (P2), the third section (P3, P3a), and the fourth section (P4, P4a). The disable control signal (GB) may have a gate-off voltage (e.g., a logic high voltage), and the enable control signal (GB) may have a gate-on voltage (e.g., a logic low voltage).

According to some embodiments, the common driver 140 may supply an enable compensation signal (GC) to the compensation line (CL) during a first sub-section (P4_1) of the fourth section (P4a), as shown in FIG. 4. The enable compensation signal (GC) may have a gate-on voltage (e.g., a logic high voltage) to allow a transistor to turn on.

According to some embodiments, as shown in FIG. 4, the common driver 140 may supply the first initialization power supply voltage (VINT1) of a second voltage (V2) to the first power line (PL1) during the third section (P3, P3a) and the first sub-section (P4_1) of the fourth section (P4, P4a), and may supply the first initialization power supply voltage (VINT1) of a first voltage (V1) during the first section (P1), the second section (P2), a second sub-section (P4_2), and the fifth section (P5, P5a). Here, the second voltage (V2) may be set to a higher voltage than the first voltage (V1). The first initialization power supply voltage (VINT1) supplied to the first power line (PL1) swings to have the first voltage (V1) and the second voltage (V2), and may thus be supplied in a pulse form from the common driver 140.

Further, the signal lines (IL1, IL2, IL3, EL1, EL2, CL, PL1) supplied with signals from the common driver 140 may be commonly connected to the pixels (PXs). The common driver 140 may be included in the timing controller 160. For example, the common driver 140 may be replaced with the timing controller 160.

The sweep driver 150 may supply a sweep signal to a sweep line (SWL). The sweep signal may be gradually reduced from the voltage of a reference power supply voltage (Vref) to a lower voltage than the reference power supply voltage (Vref) during the fifth section (P5) as shown in FIG. 4.

The power supply generator 170 may supply a voltage (e.g., a set or predetermined voltage) to the display 110. For example, the power generator 170 may supply a first power supply voltage (VDDW) to the second power line (PL2), a second power supply voltage (VDDA) to the third power line (PL3), a third power supply voltage (VSS) to the fourth power line (PL4), a second initialization power supply voltage (VINT2) to the fifth power line (PL5), and a third initialization power supply voltage (VINT3) to the sixth power line (PL6). The second power line (PL2), the third power line (PL3), the fourth power line (PL4), the fifth power line (PL5), and the sixth power line (PL6) may be commonly connected to the pixels (PXs). Additionally, the third initialization power supply voltage (VINT3) may be set to the same voltage as the second initialization power supply voltage (VINT2), and in this case, the sixth power line (PL6) may be replaced with the fifth power line (PL5).

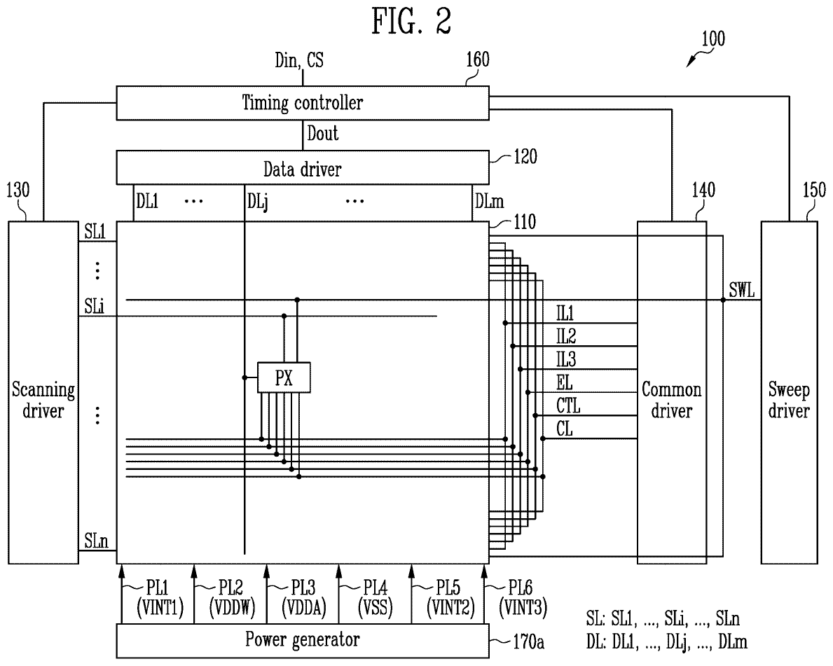

FIG. 2 is a drawing illustrating a display device according to some embodiments of the present disclosure. When explaining FIG. 2, some redundant descriptions regarding the same configuration as FIG. 1 may be omitted.

Referring to FIG. 2, the display device 100 according to some embodiments of the present disclosure may include the display 110 (or display panel), the data driver 120, the scanning driver 130, the common driver 140, the sweep driver 150, the timing controller 160, and a power generator 170a.

The power generator 170a may supply a voltage (e.g., a set or predetermined voltage) to the display 110. For example, the power generator 170a may supply the first initialization power supply voltage (VINT1) to the first power line (PL1), the first power supply voltage (VDDW) to the second power line (PL2), the second power supply voltage (VDDA) to the third power line (PL3), the third power supply voltage (VSS) to the fourth power line (PL4), the second initialization power supply voltage (VINT2) to the fifth power line (PL5), and the third initialization power supply voltage (VINT3) to the sixth power line (PL6). The first power line (PL1), the second power line (PL2), the third power line (PL3), the fourth power line (PL4), the fifth power line (PL5), and the sixth power line (PL6) may be commonly connected to the pixels (PXs). Additionally, the third initialization power supply voltage (VINT3) may be set to the same voltage as the second initialization power supply voltage (VINT2), and in this case, the sixth power line (PL6) may be replaced with the fifth power line (PL5).

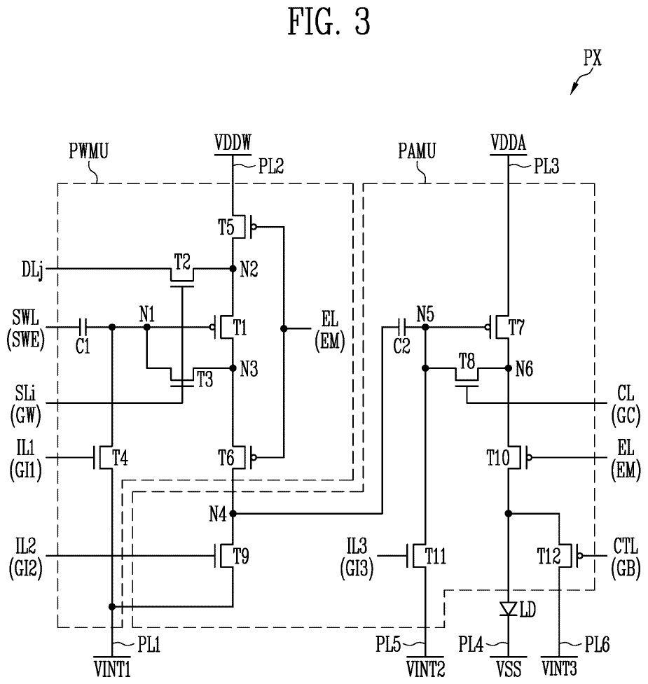

FIG. 3 is a drawing illustrating aspects of a pixel according to some embodiments of the present disclosure. Although FIG. 3 illustrates various components in a pixel according to some embodiments, embodiments according to the present disclosure are not limited thereto, and according to some embodiments, the pixel may include additional components or fewer components without departing from the spirit and scope of embodiments according to the present disclosure.

Referring to FIG. 3, a pixel (PX) according to some embodiments of the present disclosure may include a first circuit (PWMU), a second circuit (PAMU), and a light-emitting element (LD).

The light-emitting element (LD) may be connected between the second circuit (PAMU) and the fourth power line (PL4). For example, a first electrode (or an anode electrode) of the light-emitting element (LD) may be connected to the second circuit (PAMU), and a second electrode (or a cathode electrode) may be connected to the fourth power line (PL4). The light-emitting element (LD) may emit light of a brightness (e.g., a set or predetermined brightness) in response to a driving current supplied from the second circuit (PAMU).

The light-emitting element (LD) may be an inorganic light-emitting element with an inorganic semiconductor. For example, the light-emitting element (LD) may be a micro light-emitting diode element of a flip-chip type. According to some embodiments, the light-emitting element (LD) may include an organic light emitting diode, a quantum dot light emitting diode, and the like. In addition, only one light-emitting element (LD) is shown in FIG. 1, but the light-emitting element (LD) may include a plurality of micro light-emitting elements. For example, the plurality of micro light-emitting elements may be connected in series, parallel, or series-parallel.

The first circuit (PWMU) may control a supply period of the driving current supplied to the light-emitting element (LD) based on a data signal received from the data line (DLj). The data signal may be set to different voltages to correspond to the gradation to be expressed.

The first circuit (PWMU) may be a pulse width modulation (PWM) circuit. If the supply period of the driving current becomes shorter, a light-emitting period of the pixel (PX) becomes shorter, which may decrease the brightness of the pixel (PX). If the supply period of the driving current becomes longer, the light-emitting period of the pixel (PX) increases, so the brightness of the pixel (PX) may increase.

The second circuit (PAMU) may supply a driving current to the light-emitting element (LD). The second circuit (PAMU) may supply the light-emitting element (LD) with the driving current corresponding to a voltage difference of the first initialization power supply voltage (VINT1) supplied to the first power line (PL1), in other words, a difference voltage of the first voltage (V1) and the second voltage (V2). The second circuit (PAMU) may supply the driving current to the light-emitting element (LD) for a period of time (e.g., a set or predetermined period of time) in response to control of the first circuit (PWMU).

The first circuit (PWMU) may include a first transistor (T1), a second transistor (T2), a third transistor (T3), a fourth transistor (T4), a fifth transistor (T5), a sixth transistor (T6), and a first capacitor (C1).

A first electrode of the first transistor (T1) (or a first driving transistor) is connected to a second node (N2), and a second electrode is connected to a third node (N3). Further, a gate electrode of the first transistor (T1) is connected to a first node (N1). The first transistor (T1) may control the amount of current flowing from the second power line (PL2) supplied with the first power supply voltage (VDDW) to a fourth node (N4) (or a common node) in response to the voltage of the first node (N1). The first power supply voltage (VDDW) may be set to a sufficiently high voltage so that current can flow from the second power line (PL2) to the fourth node (N4).

A first electrode of the second transistor (T2) is connected to the data line (DLj), and a second electrode is connected to the second node (N2). Further, a gate electrode of the second transistor (T2) is connected to the scanning line (SLi). The second transistor (T2) may be turned on when an enable scanning signal (GW) is supplied to the scanning line (SLi) to electrically connect the data line (DLj) to the second node (N2).

A first electrode of the third transistor (T3) is connected to the third node (N3), and a second electrode is connected to the first node (N1). Further, a gate electrode of the third transistor (T3) is connected to the scanning line (SLi). The third transistor (T3) may be turned on when an enable scanning signal (GW) is supplied to the scanning line (SLi) to electrically connect the first node (N1) and the third node (N3). When the third transistor (T3) is turned on, the first transistor (T1) may be connected in a diode form.

A first electrode of the fourth transistor (T4) is connected to the first node (N1), and a second electrode is connected to the first power line (PL1). Further, a gate electrode of the fourth transistor T4 is connected to the first initialization line (IL1). The fourth transistor (T4) may be turned on when the first initialization line (IL1) is supplied with the enable first initialization signal (GI1) to electrically connect the first power line (PL1) and the first node (N1).

A first electrode of the fifth transistor (T5) is connected to the second power line (PL2), and a second electrode is connected to the second node (N2). Further, a gate electrode of the fifth transistor (T5) is connected to the light-emitting control line (EL). The fifth transistor (T5) may be turned off when the disable light-emitting control signal (EM) is supplied to the light-emitting control line (EL) and turned on when the enable light-emitting control signal (EM) is supplied.

A first electrode of the sixth transistor (T6) is connected to the third node (N3), and a second electrode is connected to the fourth node (N4). Further, a gate electrode of the sixth transistor (T6) is connected to the light-emitting control line (EL). The sixth transistor (T6) may be turned off when the disable light-emitting control signal (EM) is supplied to the light-emitting control line (EL) and turned on when the enable-emitting control signal (EM) is supplied.

A first electrode of the first capacitor (C1) is connected to the sweep line (SWL), and a second electrode is connected to the first node (N1). The first capacitor (C1) is driven by a coupling capacitor and may transmit voltage changes in the sweep line (SWL) to the first node (N1).

The second circuit (PAMU) may include a seventh transistor (T7), an eighth transistor (T8), a ninth transistor (T9), a tenth transistor (T10), an eleventh transistor (T11), a twelfth transistor (T12), and a second capacitor (C2).

A first electrode of the seventh transistor (T7) (or a second driving transistor) is connected to the third power line (PL3), and a second electrode is connected to a sixth node (N6). Further, a gate electrode of the seventh transistor (T7) is connected to a fifth node (N5). The seventh transistor (T7) may control the amount of current supplied to the light-emitting element (LD) from the third power line (PL3) to which the second power supply voltage (VDDA) is supplied in response to the voltage of the fifth node (N5). At this time, a driving current may be supplied from the third power line (PL3) to the fourth power line (PL4) to which the third power supply voltage (VSS) is supplied via the seventh transistor (T7), the tenth transistor (T10), and the light-emitting element (LD). A second electrode of the light-emitting element (LD) is connected to the fourth power line (PL4) to which the third power supply voltage (VSS) is supplied, and the third power supply voltage (VSS) may be set to a lower voltage than the second power supply voltage (VDDA).

A first electrode of the eighth transistor (T8) is connected to the sixth node (N6), and the second electrode is connected to the fifth node (N5). Further, a gate electrode of the eighth transistor (T8) is connected to the compensation line (CL). The eighth transistor (T8) may be turned on when the enable compensation signal (GC) is supplied to the compensation line (CL) to electrically connect the fifth node (N5) to the sixth node (N6). When the eighth transistor (T8) is turned on, the seventh transistor (T7) may be connected in a diode form.

A first electrode of the ninth transistor (T9) is connected to the fourth node (N4), and a second electrode is connected to the first power line (PL1). Further, a gate electrode of the ninth transistor (T9) is connected to the second initialization line (IL2). The ninth transistor (T9) may be turned on when the enable second initialization signal (GI2) is supplied to the second initialization line (IL2) to electrically connect the first power line (PL1) and the fourth node (N4).

A first electrode of the tenth transistor (T10) is connected to the sixth node (N6), and a second electrode is connected to the first electrode of the light-emitting element (LD). Further, a gate electrode of the tenth transistor (T10) is connected to the light-emitting control line (EL). The tenth transistor (T10) may be turned off when the disable light-emitting control signal (EM) is supplied to the light-emitting control line (EL) and may be turned on when the enable light-emitting control signal (EM) is supplied.

A second electrode of the eleventh transistor (T11) is connected to the fifth power line (PL5), and a first electrode is connected to the fifth node (N5). Further, a gate electrode of the eleventh transistor (T11) is connected to the third initialization line (IL3). The eleventh transistor (T11) may be turned on when the third initialization line (IL3) is supplied with the enable third initialization signal (GI3) to electrically connect the fifth power line (PL5) to the fifth node (N5).

A first electrode of the twelfth transistor (T12) is connected to the first electrode of the light-emitting element (LD), and a second electrode is connected to the sixth power line (PL6). Further, a gate electrode of the twelfth transistor (T12) is connected to the control line (CTL). The twelfth transistor (T12) may be turned off when the disable control signal (GB) is supplied to the control line (CTL) and turned on when the enable control signal (GB) is supplied.

The voltage of the third initialization power supply voltage (VINT3) may supplied to the sixth power line (PL6), and the voltage of the third initialization power supply voltage (VINT3) may be set to discharge a parasitic capacitor of the light-emitting element (LD). The voltage of the third initialization power supply voltage (VINT3) may be set so that the light-emitting element (LD) does not emit light. When the parasitic capacitor of the light-emitting element (LD) is discharged, the black expression capability of the pixel (PX) may be relatively improved.

The second capacitor (C2) is connected between the fourth node (N4) and the fifth node (N5). The second capacitor (C2) may change the voltage of the fifth node (N5) in response to voltage changes of the fourth node (N4). The second capacitor (C2) may be driven by a coupling capacitor.

According to some embodiments, the first transistor (T1), fifth transistor (T5), sixth transistor (T6), seventh transistor (T7), tenth transistor (T10), and twelfth transistor (T12) may be formed from polysilicon semiconductor transistors. For example, each of the first transistor (T1), fifth transistor (T5), sixth transistor (T6), seventh transistor (T7), tenth transistor (T10), and twelfth transistor (T12) may include a polysilicon semiconductor layer formed through a low temperature poly-silicon (LTPS) process as an active layer (channel). In addition, the first transistor (T1), fifth transistor (T5), sixth transistor (T6), seventh transistor (T7), tenth transistor (T10), and twelfth transistor (T12) may be P-type transistors (e.g., PMOS). Accordingly, the gate-on voltage which turns on each of the first transistor (T1), fifth transistor (T5), sixth transistor (T6), seventh transistor (T7), tenth transistor (T10), and twelfth transistor (T12) may be a logic low level. Because a polysilicon semiconductor transistor may have a relatively fast response speed, it may be applied to a switching element which requires fast switching.

According to some embodiments, the second transistor (T2), the third transistor (T3), the fourth transistor (T4), the eighth transistor (T8), the ninth transistor (T9), and the eleventh transistor (T11) may be formed as oxide semiconductor transistors. For example, each of the second transistor (T2), the third transistor (T3), the fourth transistor (T4), the eighth transistor (T8), the ninth transistor (T9), and the eleventh transistor (T11) may be an N-type oxide semiconductor transistor (e.g., NMOS transistor) and may include an oxide semiconductor layer as an active layer. Accordingly, the gate-on voltage which turns on each of the second transistor (T2), third transistor (T3), fourth transistor (T4), eighth transistor (T8), ninth transistor (T9), and eleventh transistor (T11) may be a logic high level.

An oxide semiconductor transistor may be processed at low temperatures and has lower charge mobility than the polysilicon semiconductor transistor. In other words, the oxide semiconductor transistor has excellent off-current characteristics. Therefore, if the second transistor (T2), third transistor (T3), fourth transistor (T4), eighth transistor (T8), ninth transistor (T9), and eleventh transistor (T11) are formed with oxide semiconductor transistors, leakage current due to low-frequency driving may be minimized, thereby relatively improving display quality.

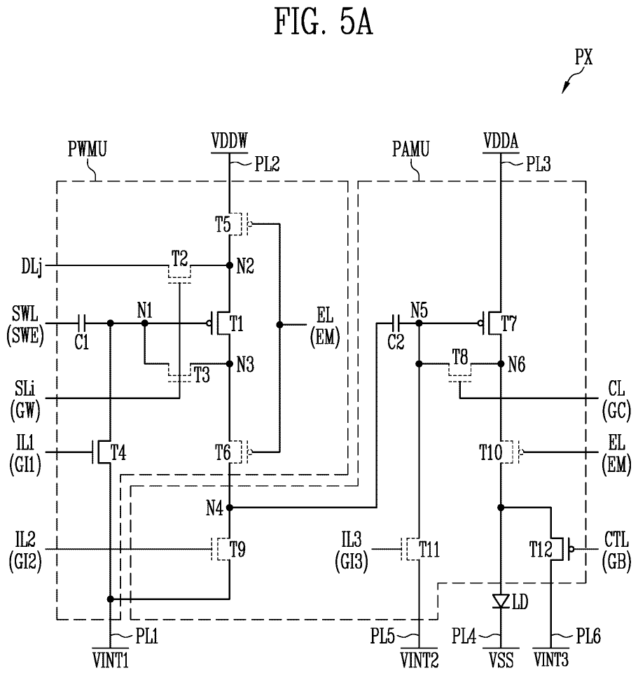

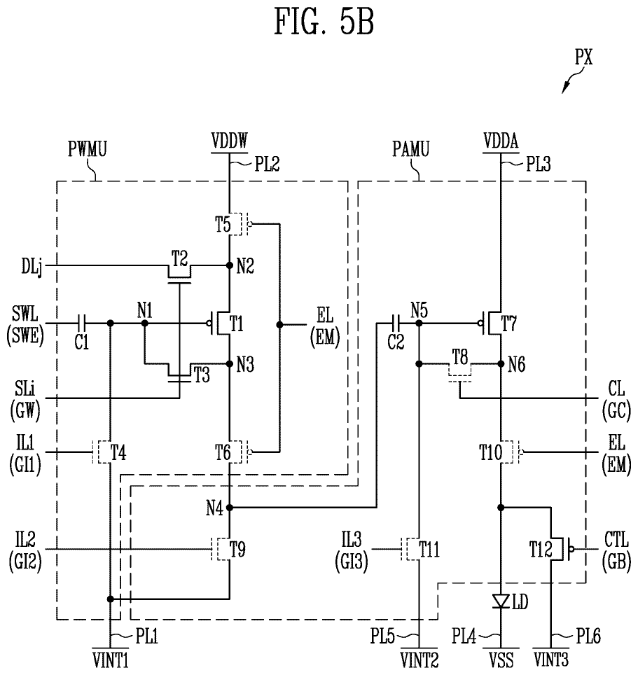

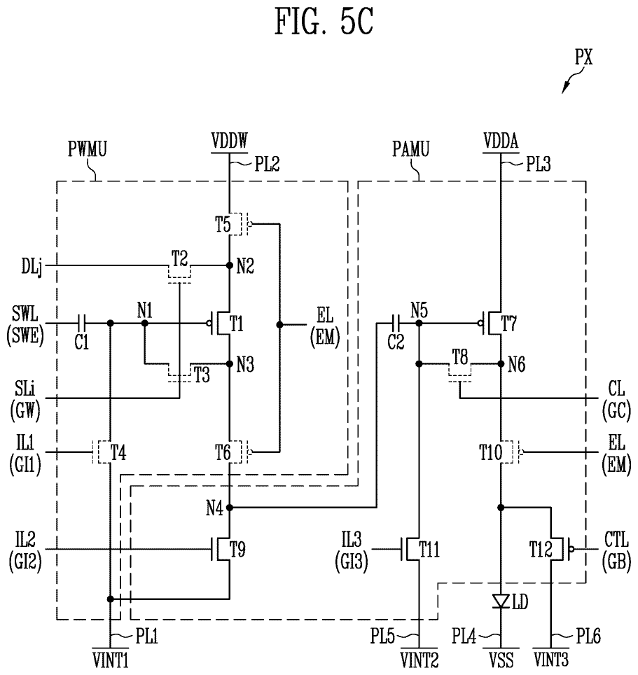

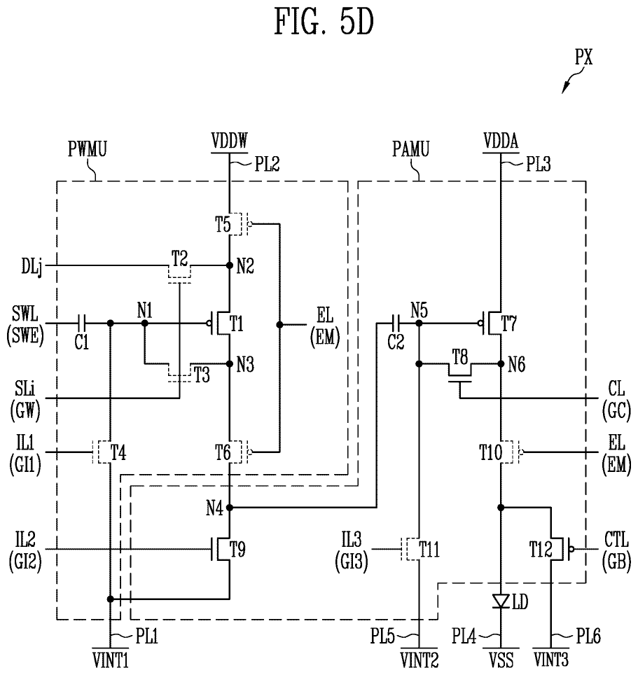

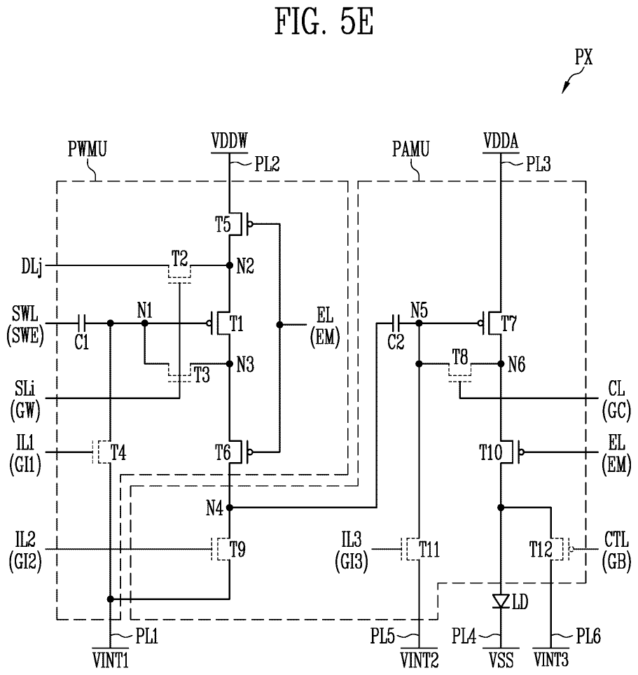

FIG. 4 is a waveform diagram illustrating aspects of a method of driving the pixel shown in FIG. 3 according to some embodiments. FIGS. 5A to 5E are drawings illustrating aspects of an operation process of the pixel in correspondence to the waveform diagram of FIG. 4.

Referring to FIG. 4, one frame period may include the first section P1, the second section P2, the third section P3, the fourth section P4, and the fifth section P5. In addition, one frame (1 Frame) period may include the third section (P3a), the fourth section (P4a), and the fifth section (P5a).

The common driver 140 may supply the enable control signal (GB) to the control line (CTL) during the first section (P1), the second section (P2), the third section (P3), and the fourth section (P4), and thus the twelfth transistor (T12) may be set to a turn-on state during the first section (P1), the second section (P2), the third section (P3), and the fourth section (P4). When the twelfth transistor (T12) is turned on, the voltage of the third initialization power supply voltage (VINT3) may be supplied to the first electrode of the light-emitting element (LD), and accordingly, the light-emitting element (LD) may be set to a non light-emitting state.

The first section (P1) may be the one where the first capacitor C1 (or the first node N1) is initialized. The first section (P1) may be named the first initialization section.

The second section (P2) may be the section where the voltage corresponding to the data signal and a threshold voltage of the first transistor T1 is stored in the first capacitor C1. The second section (P2) may be named as the first data entry section.

The third section (P3) may be the one where the second capacitor C2 (or the fifth node N5) is initialized. The third section (P3) may be named the second initialization section.

The fourth section (P4) may be the section in which the voltage corresponding to the voltage difference between the first voltage (V1) and the second voltage (V2) and the voltage corresponding to a threshold voltage of the seventh transistor (T7) are stored in the second capacitor (C2). The fourth section (P4) may be designated as the second data entry section.

The fifth interval (P5) may be the zone where pixels (PX) are emitted during the time corresponding to the data signal. The fifth section (P5) can be named the luminous section.

During the first section (P1), the enable first initialization signal (GI1) may be supplied to the first initialization line (IL1). When the enable first initialization signal (GI1) is supplied to the first initialization line (IL1), the fourth transistor (M4) may be turned on as shown in FIG. 5A. When the fourth transistor (T4) is turned on, the first voltage (V1) of the first initialization power supply voltage (VINT1) may be supplied to the first node (N1). The first voltage (V1) may be set to a voltage at which the first transistor (T1) can be turned on, for example, to a voltage lower than the data signal.

During the first section (P1), the sweep line (SWL) may be supplied with the voltage of the reference power supply voltage (Vref). Thus, during the first section (P1), the first capacitor (C1) may be initialized by the reference power supply voltage (Vref) and the first initialization power supply voltage (VINT1) (i.e., the first voltage (V1)). In addition, the sweep line (SWL) may be provided with the reference power supply voltage (Vref) during the first section (P1) to the fourth section (P4).

During the second section (P2), the enable scanning signal (GW) may be sequentially supplied to the scanning line (SL). Then, during the second section (P2), the data signal may be supplied to the data line (DL). The data signal may have different voltages for different pixels (PXs) in correspondence to the gradation to be expressed.

When the enable scanning signal (GW) is supplied to the scanning line (SLi), the second transistor (T2) and the third transistor (T3) may be turned on as shown in FIG. 5B. When the second transistor (T2) is turned on, the data line (DLj) and the second node (N2) may be electrically connected. When the third transistor (T3) is turned on, the first node (N1) and the third node (N3) may be electrically connected. Then, the data signal supplied from the data line (DLj) to the second node (N2) may be supplied to the first node (N1) via the first transistor (T1) and the third transistor (T3). Since the first transistor (T1) is connected in a diode form, the voltage supplied to the first node (N1) is a compensation voltage in which the threshold voltage of the first transistor (T1) is reflected in the data signal. In this case, the threshold voltage deviation due to the processing deviation of the first transistor (T1) may be compensated. During the second section (P2), the first capacitor (C1) may store the compensation voltage applied to the first node (N1).

During the third section (P3), the enable second initialization signal (GI2) may be supplied to the second initialization line (IL2), and the enable third initialization signal (GI3) may be supplied to the third initialization line (IL3). Further, during the third section (P3), the first initialization power supply voltage (VINT1) may be set to the second voltage (V2).

When the enable second initialization signal (GI2) is supplied to the second initialization line (IL2), the ninth transistor (T9) may be turned on as shown in FIG. 5C. When the ninth transistor (T9) is turned on, the fourth node (N4) may be supplied with the first initialization power supply voltage (VINT1) of the second voltage (V2).

When the enable third initialization signal (GI3) is supplied to the third initialization line (IL3), the eleventh transistor (T11) may be turned on. When the eleventh transistor (T11) is turned on, the voltage of the second initialization power supply voltage (VINT2) may be supplied to the fifth node (N5). Then, during the third section (P3), the second capacitor (C2) may be initialized by the first initialization power supply voltage (VIN1) of the second voltage (V2) and the second initialization power supply voltage (VINT2). The voltage of the second initialization power supply voltage (VINT2) may be set to allow the seventh transistor (T7) to be turned on.

During the first sub-section (P4_1) of the fourth section (P4), the compensation signal (GC) is supplied to the compensation line (CL), and the first initialization power supply voltage (VINT1) may maintain the second voltage (V2). Further, during the fourth section (P4), the enable second initialization signal (GI2) is supplied to the second initialization line (IL2) so that the ninth transistor (T9) may maintain a turn-on state as shown in FIG. 5D.

When the compensation signal (GC) is supplied to the compensation line (CL), the eighth transistor (T8) may be turned on as shown in FIG. 5D. When the eighth transistor T8 is turned on, the seventh transistor (T7) may be connected in a diode form. Then, a voltage obtained by subtracting the absolute threshold voltage of the seventh transistor (T7) from the second power supply voltage (VDDA) may be applied to the fifth node (N5). At this time, a voltage between the second voltage (V2) and the fifth node (N5) is stored in the second capacitor (C2), and accordingly, the threshold voltage of the seventh transistor (T7) may be compensated.

During the second sub-section (P4_2) of the fourth section (P4), the disable compensation signal (GC) is supplied to the compensation line (CL), and the eighth transistor (T8) is set to a turn-off state. Then, during the second sub-section (P4_2), the voltage of the first initialization power supply voltage (VINT1) may be lowered from the second voltage (V2) to the first voltage (V1). In this case, the voltage of the fourth node (N4) is lowered from the second voltage (V2) to the first voltage (V1). In addition, by coupling of the second capacitor (C2), the voltage of the fifth node (N5) may also be lowered in response to a voltage drop of the fourth node (N4).

In this case, the voltage applied to the fifth node (N5) may be determined by the difference voltage of the first voltage (V1) and the second voltage (V2). Here, the difference voltage of the first voltage (V1) and the second voltage (V2) may be determined experimentally so that a constant current can flow in the seventh transistor (T7). The seventh transistor (T7) may supply a driving current (e.g., a set or predetermined driving current) in correspondence to the voltage of the fifth node (N5).

During the fifth section (P5), the enable light-emitting control signal (EM) may be supplied to the light-emitting control line (EL) and the disable control signal (GB) may be supplied to the control line (CTL). When the disable control signal (GB) is supplied to the control line (CTL), the twelfth transistor (T12) is turned off as shown in FIG. 5E.

When the twelfth transistor (T12) is turned off, the driving current supplied from the seventh transistor (T7) may be supplied to the fourth power line (PL4) via the light-emitting element (LD). Then, the light-emitting element (LD) may emit light at a brightness (e.g., a set or predetermined brightness) by the driving current supplied from the seventh transistor (T7).

When the enable light-emitting control signal (EM) is supplied to the light-emitting control line (EL), the fifth transistor (T5) and the sixth transistor (T6) may be turned on. When the fifth transistor (T5) is turned on, the second power line (PL2) and the first transistor (T1) may be electrically connected. When the sixth transistor (T6) is turned on, the first transistor (T1) and the fourth node (N4) may be electrically connected.

Further, the sweep signal (SWE) may be supplied to the sweep line (SWL) during the fifth section (P5). The sweep signal (SWE) may be gradually reduced from the voltage of the reference power supply voltage (Vref) to a voltage lower than the reference power supply voltage (Vref).

At this time, by coupling of the first capacitor (C1), the voltage of the first node (N1) is also gradually reduced. The higher the voltage of the data signal supplied during the second section (P2), the later the time at which the first transistor (T1) is turned on may be. The lower the voltage of the data signal supplied during the second section (P2), the earlier the time at which the first transistor (T1) is turned on may be. If the first transistor (T1) is turned on during the fifth section (P5), the voltage of the fourth node (N4) may increase, and accordingly, the voltage of the fifth node (N5) may also increase.

When the voltage of the fifth node (N5) is raised, the seventh transistor (T7) may be turned off. When the seventh transistor (T7) is turned off, the current path is blocked, and accordingly, the supply of the driving current to the light-emitting element (LD) is interrupted, so that the light-emitting element (LD) may be set to a non light-emitting state. The sooner the driving current is interrupted, the lower the brightness of the pixel (PX) visually recognized during that frame period. The later the driving current is interrupted, the higher the brightness of the pixel (PX) visually recognized during that frame period.

According to some embodiments, the first power supply voltage (VDDW) and the second power supply voltage (VDDA) may be set to different voltages. For example, the first power supply voltage (VDDW) may be set to a voltage so that the voltage of the fourth node (N4) may be increased in response to the data signal. For example, the second power supply voltage (VDDA) may be configured to supply a constant-current driving current to the light emitting element (LD) while the seventh transistor is driven in a saturation region in response to the voltage of the fifth node (N5).

In addition, the third section (P3a), the fourth section (P4a), and the fifth section (P5a) may be included at least once during the period of one frame (1 Frame). For example, the number of the third sections (P3a), the fourth sections (P4a), and the fifth sections (P5a) included in one frame (1 Frame) may be determined in correspondence to the length (or an image refresh rate) of one frame (1 Frame). For example, as the length of one frame (1 Frame) increases, the number of the third sections (P3a), the fourth sections (P4a), and the fifth sections (P5a) may increase.

During the third section (P3a), the fourth node (N5) and the fifth node (N5) may be initialized. During the fourth section (P4a), the voltage corresponding to the threshold voltage of the seventh transistor (T7) and a voltage (e.g., a set or predetermined voltage) may be stored in the second capacitor (C2). During the fifth section (P5a), the pixel (PX) may emit light.

As described above, the pixel (PX) of the present disclosure may implement gradations using the light-emitting time. In the case of implementing gradations using the light-emitting time, the light-emitting element may be driven using a constant current (i.e., driving current), and thus the display quality may be relatively improved.

For example, in the case that the amount of driving current is controlled in correspondence to the voltage of the data signal, the wavelength may shift in correspondence to the current density, resulting in a decrease in display quality. In particular, in the case that the light-emitting element (LD) is applied as a micro LED for application to a high-resolution panel, wavelength shift characteristic according to the current density becomes large, so a desired image may not be displayed.

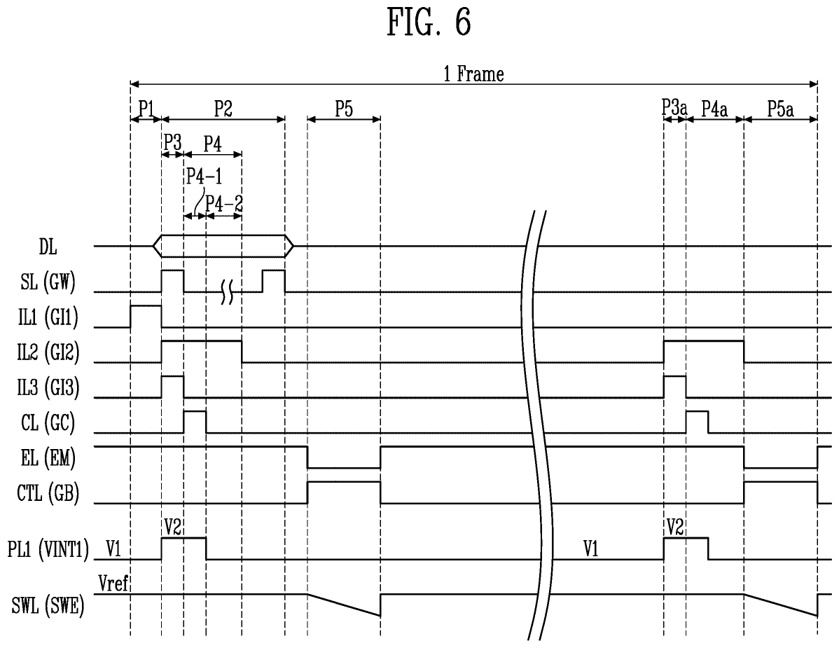

FIG. 6 is a waveform diagram illustrating aspects of a method of driving the pixel shown in FIG. 3 according to some embodiments. In describing FIG. 6, description of some parts described with reference to FIG. 4 may be briefly described or omitted.

Referring to FIG. 6, the second section (P2) may overlap with the third section (P3) and the fourth section (P4). In other words, during the period for which the data signal is stored in the first circuit (PWMU) (i.e., the second section (P2)), a voltage corresponding to the difference between the first voltage (V1) and the second voltage (V2) may be stored in the second capacitor (C2) of the second circuit (PAMU).

During the first section (P1), the enable first initialization signal (GI1) is supplied to the first initialization line (IL1), and accordingly, the fourth transistor (M4) may be turned on. When the fourth transistor (T4) is turned on, the first voltage (V1) of the first initialization power supply voltage (VINT1) may be supplied to the first node (N1). Then, during the first section (P1), the first capacitor (C1) may be initialized by the reference power supply voltage (Vref) and the first initialization power supply voltage (VINT1) (i.e., the first voltage (V1)).

During the second section (P2), the enable scanning signal (GW) may be sequentially supplied to the scanning line (SL). Then, during the second section (P2), the data signal may be supplied to the data line (DL).

When the enable scanning signal (GW) is supplied to the scanning line (SLi), the second transistor (T2) and third transistor (T3) may be turned on. When the second transistor (T2) is turned on, the data line (DLj) and the second node (N2) may be electrically connected. When the third transistor (T3) is turned on, the first node (N1) and the third node (N3) may be electrically connected. The data signal supplied from the data line (DLj) to the second node (N2) may then be supplied to the first node (N1) via the first transistor (T1) and the third transistor (T3). Since the first transistor (T1) is connected in a diode form, the voltage supplied to the first node (N1) is a compensation voltage in which the threshold voltage of the first transistor (T1) is reflected in the data signal. In this case, the threshold voltage deviation due to the processing deviation of the first transistor (T1) may be compensated. During the second section (P2), the compensation voltage applied to the first node (N1) may be stored in the first capacitor (C1).

During the third section (P3) which overlaps with the second section (P2), the enable second initialization signal (GI2) may be supplied to the second initialization line (IL2), and the enable third initialization signal (GI3) may be supplied to the third initialization line (IL3).

When the enable second initialization signal (GI2) is supplied to the second initialization line (IL2), the ninth transistor (T9) may be turned on. When the ninth transistor (T9) is turned on, the fourth node (N4) may be supplied with the first initialization power supply voltage (VINT1) of the second voltage (V2). When the enable third initialization signal (GI3) is supplied to the third initialization line (IL3), the eleventh transistor (T11) may be turned on. When the eleventh transistor (T11) is turned on, the voltage of the second initialization power supply voltage (VINT2) may be supplied to the fifth node (N5). Then, during the third section (P3), the second capacitor (C2) may be initialized by the first initialization power supply voltage (VIN1) of the second voltage (V2) and the second initialization power supply voltage (VINT2).

During the first sub-section (P4_1) of the fourth section (P4) which overlaps with the second section (P2), the compensation signal (GC) is supplied to the compensation line (CL). When the compensation signal (GC) is supplied to the compensation line (CL), the eighth transistor (T8) may be turned on. When the eighth transistor (T8) is turned on, the seventh transistor (T7) may be connected in a diode form. Then, a voltage obtained by subtracting the absolute threshold voltage of the seventh transistor (T7) from the second power supply voltage (VDDA) may be applied to the fifth node (N5). At this time, a voltage between the second voltage (V2) and the fifth node (N5) is stored in the second capacitor (C2), and accordingly, the threshold voltage of the seventh transistor (T7) may be compensated.

During the second sub-section (P4_2) of the fourth section (P4) which overlaps with the second section (P2), the disable compensation signal (GC) is supplied to the compensation line (CL), and accordingly, the eighth transistor (T8) is set to the turn-off state. Then, during the second sub-section (P4_2), the voltage of the first initialization power supply voltage (VINT1) may be lowered from the second voltage (V2) to the first voltage (V1). In this case, the voltage of the fourth node (N4) is lowered from the second voltage (V2) to the first voltage (V1). In addition, by the coupling of the second capacitor (C2), the voltage of the fifth node (N5) may also be lowered in response to the voltage drop of the fourth node (N4).

During the fifth section (P5), the enable light-emitting control signal (EM) may be supplied to the light-emitting control line (EL) and the disable control signal (GB) may be supplied to the control line (CTL). The light-emitting element (LD) may then emit light at a brightness (e.g., a set or predetermined brightness) by the driving current supplied from the seventh transistor (T7).

As shown in FIG. 6, if the third section (P3) and the fourth section (P4) overlap with the second section (P2), sufficient driving time of the pixel (PX) may be secured.

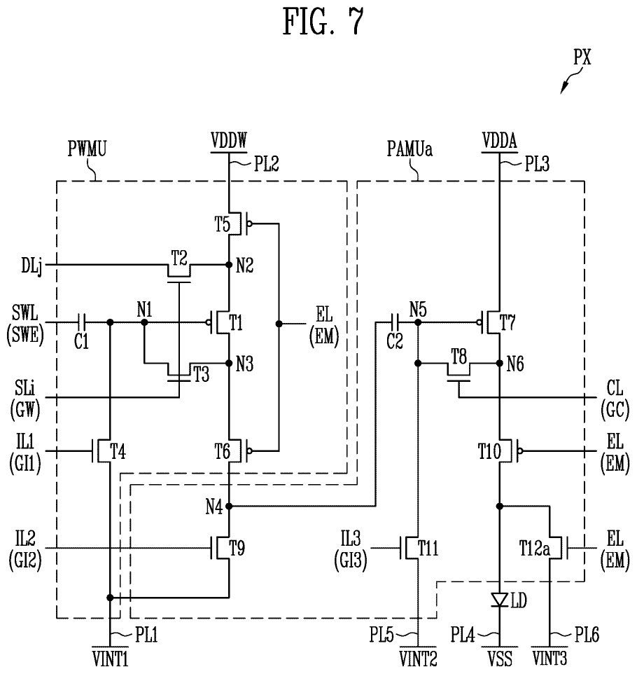

FIG. 7 is a drawing illustrating aspects of a pixel according to some embodiments of the present disclosure. Although FIG. 7 illustrates various components in a pixel according to some embodiments, embodiments according to the present disclosure are not limited thereto, and according to some embodiments, the pixel may include additional components or fewer components without departing from the spirit and scope of embodiments according to the present disclosure. In describing FIG. 7, some duplicate descriptions regarding the same configuration as FIG. 3 may be omitted.

Referring to FIG. 7, a pixel (PX) according to some embodiments of the present disclosure may include the first circuit (PWMU), a second circuit (PAMUa), and the light-emitting element (LD).

The second circuit (PAMUa) may supply a driving current to the light-emitting element (LD). The driving current may be set to a constant current, and the second circuit (PAMUa) may supply the driving current to the light-emitting element (LD) for a time (e.g., a set or predetermined time) in response to control of the first circuit (PWMU).

The second circuit (PAMUa) may include the seventh transistor (T7), the eighth transistor (T8), the ninth transistor (T9), the tenth transistor (T10), the eleventh transistor (T11), a twelfth transistor (T12a), and the second capacitor (C2).

A first electrode of the twelfth transistor (T12a) is connected to the first electrode of the light-emitting element (LD), and a second electrode of the twelfth transistor (T12a) is connected to the sixth power line (PL6). Further, a gate electrode of the twelfth transistor (T12a) is connected to the light emitting control line (EL). The twelfth transistor (T12a) may be turned on when the disable light-emitting control signal (EM) is supplied to the light-emitting control line (EL) and may be turned off when the enable light-emitting control signal (EM) is supplied.

The twelfth transistor (T12a) may be formed from an oxide semiconductor transistor. For example, the twelfth transistor (T12a) may be an N-type oxide semiconductor transistor (e.g., NMOS transistor) and may include an oxide semiconductor layer as an active layer. Accordingly, a gate-on voltage which turns on the twelfth transistor (T12a) may be a logic high level.

When the twelfth transistor (T12a) is formed as an N-type transistor, the twelfth transistor (T12a) may be connected to the light-emitting control line (EL). In this case, the control line (CTL) shown in FIG. 3 may be removed.

More specifically, the light-emitting control signal (EM) supplied to the light-emitting control line (EL) may be a signal whose phase is inverted from that of the control signal (GB) supplied to the control line (CTL). Therefore, if the twelfth transistor (T12a) is formed as an N-type transistor and is supplied with the first light-emitting control signal (EM), it may be driven in the same way as the pixel of FIG. 3.

In the case that the twelfth transistor (T12a) is connected to the light-emitting control line (EL), the twelfth transistor (T12a) may be turned off during the fifth section (P5, P5a) of the sections of one frame (1 Frame). Therefore, during the fifth section (P5, P5a), the driving current supplied from the seventh transistor (T7) may be supplied to the fourth power line (PL4) via the light-emitting element (LD).

When the twelfth transistor (T12a) is connected to the light-emitting control line (EL), the twelfth transistor (T12a) may be turned on during the first section (P1), the second section (P2), the third section (P3, P3a), and the fourth section (P4, P4a) of the sections of one frame (1 Frame). Therefore, during the first section (P1), the second section (P2), the third section (P3, P3a), and the fourth section (P4, P4a), the first electrode of the light-emitting element (LD) may be supplied with the third initialization power supply voltage (VINT3).

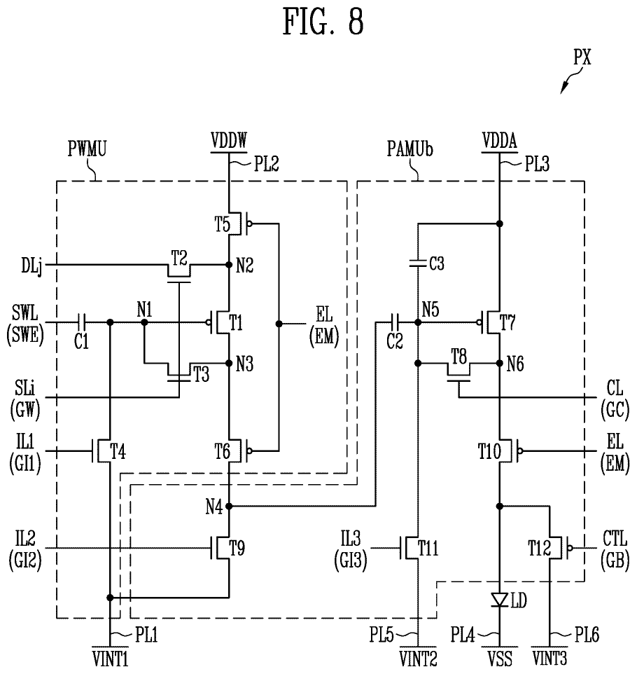

FIG. 8 is a drawing illustrating aspects of a pixel according to some embodiments of the present disclosure. Although FIG. 8 illustrates various components in a pixel according to some embodiments, embodiments according to the present disclosure are not limited thereto, and according to some embodiments, the pixel may include additional components or fewer components without departing from the spirit and scope of embodiments according to the present disclosure. In describing FIG. 8, some duplicate descriptions regarding the same configuration as FIG. 3 may be omitted.

Referring to FIG. 8, a pixel (PX) according to some embodiments of the present disclosure may include the first circuit (PWMU), a second circuit (PAMUb), and the light-emitting element (LD).

The second circuit (PAMUb) may supply a driving current to the light-emitting element (LD). The driving current may be set to a constant current, and the second circuit (PAMUb) may supply the driving current to the light-emitting element (LD) for a period of time (e.g., a set or predetermined period of time) in response to control of the first circuit (PWMU).

The second circuit (PAMUb) may include the seventh transistor (T7), the eighth transistor (T8), the ninth transistor (T9), the tenth transistor (T10), the eleventh transistor (T11), the twelfth transistor (T12), the second capacitor (C2), and a third capacitor (C3).

The third capacitor (C3) is connected between the third power line (PL3) and the fifth node (N5). The third capacitor (C3) may keep the voltage of the fifth node (N5) stable.

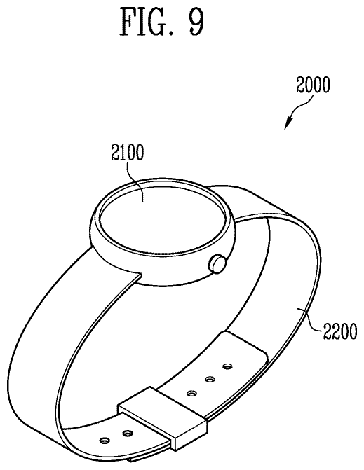

FIGS. 9 to 12 are perspective views illustrating application examples of a display device according to some embodiments of the present disclosure.

Referring to FIG. 9, the display device 100 according to some embodiments of the present disclosure may be applied to a smart watch 2000 including a display 2100 and a strap part 2200.

The smart watch 2000 may be a wearable electronic device. For example, the smart watch 2000 may have a configuration in which the strap part 2200 is mounted on a user's wrist. Here, the display device 100 (or the display 110) is applied to the display (2100), so that image data including time information may be provided to the user.

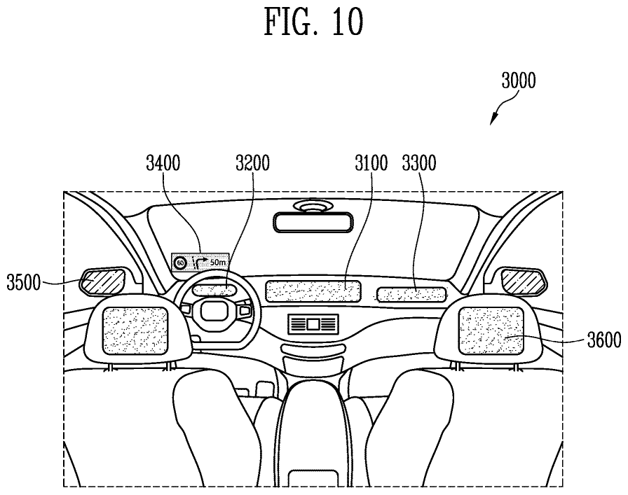

Referring to FIG. 10, the display device 100 according to some embodiments of the present disclosure may be applied to an automotive display system 3000. Here, the automotive display system 3000 may include a computing system which is equipped inside and/or outside a vehicle to provide image data.

For example, the display device 100 may be incorporated into an automobile and/or an automobile dashboard, a display console, a headrest, a mirror and the like, and may be applied to at least one of an infortainment panel 3100, a cluster 3200, a co-driver display 3300, a head-up display 3400, a side mirror display 3500, or a rear seat display 3600 provided in the vehicle.

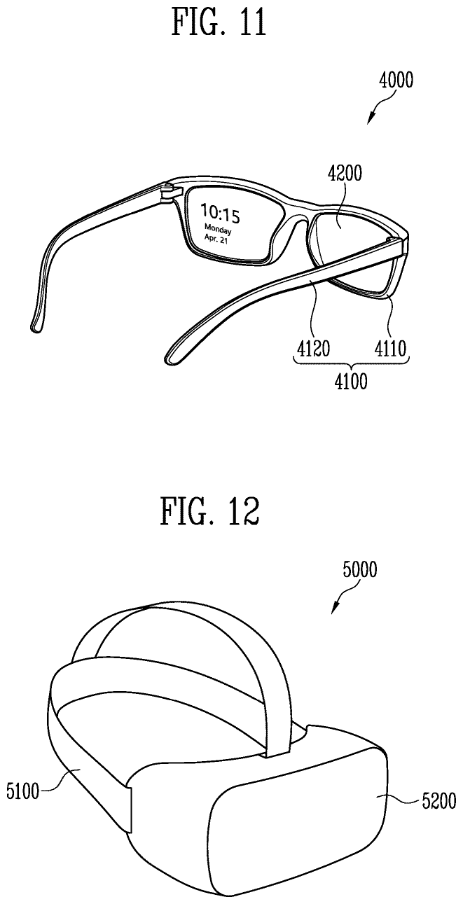

Referring to FIG. 11, the display device 100 according to some embodiments of the present disclosure may be applied to smart glasses 4000 (e.g., a wearable glasses device). The smart glasses 4000 may be a wearable electronic device which may be worn on the user's head. For example, the smart glasses 4000 may be a wearable device for augmented reality.

The smart glasses 4000 may include a frame 4100 and a lens part 4200. The frame 4100 may include a housing 4110 to support the lens part 4200 and a leg part 4120 for wearing by the user. The leg part 4120 is connected to the housing 4110 via a hinge and may be folded or unfolded relative to the housing 4110.

The frame 4100 may be equipped with a battery, a touch pad, a microphone, a camera, and the like. In addition, the frame 4100 may be equipped with a projector which outputs light, a processor which controls light signals, and the like.

The lens part 4200 may include an optical member which transmits light or reflects light. For example, the lens part 4200 may include glass, transparent synthetic resin, and the like.

To allow the user's eyes to recognize visual information, the lens part 4200 may reflect an image by an optical signal transmitted from the projector of the frame (4100) by a rear surface of the lens part 4200 (e.g., a surface facing the user's eyes). For example, the user may recognize visual information such as time and date displayed on the lens part 4200. Here, the projector and/or lens part 4200 may be a kind of display device. The display device 100 may be applied to the projector and/or the lens part 4200.

Referring to FIG. 12, the display device 100 according to some embodiments of the present disclosure may be applied to a head-mounted display apparatus 5000.

The head-mounted display apparatus 5000 may be a wearable electronic device which can be worn on the user's head. For example, the head-mounted display apparatus 5000 may be a wearable device for virtual reality or mixed reality.

The head-mounted display apparatus 5000 may include a head-mounted band 5100 and a display device storage case 5200. The head-mounted band 5100 may be connected to the display device storage case 5200. The head-mounted band 5100 may include a horizontal band and/or a vertical band for fixing the head-mounted display apparatus 5000 to the user's head. The horizontal band may be configured to surround sides of the user's head, and the vertical band may be configured to surround an upper part of the user's head. However, embodiments according to the present disclosure are not limited thereto. For example, the head-mounted band 5100 may be implemented in the form of a glasses frame, a helmet, and the like.

A display device according to an embodiment is applicable to various types of electronic devices. In an embodiment, an electronic device includes the above-described display device and may further include other modules or devices having additional functions in addition to the display device.

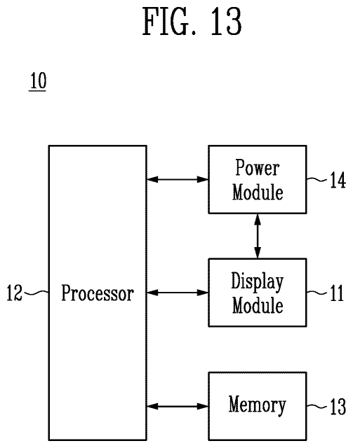

FIG. 13 is a block diagram of an electronic device according to an embodiment. Referring to FIG. 13, the electronic device 10 may include a display module 11, a processor 12, a memory 13, and a power module 14.

The processor 12 may include at least one of a central processing unit (CPU), an application processor (AP), a graphic processing unit (GPU), a communication processor (CP), an image signal processor (ISP), and a controller.

The memory 13 may store data and/or information used to operate the processor 12 or the display module 11. When the processor 12 executes an application stored in the memory 13, image data signals and/or input control signals may be transferred to the display module 11. The display module 11 may process the provided signals and output image information on a display screen.

The power module 14 may include a power supply module, such as a power adapter or a battery device, and a power conversion module. The power conversion module converts power supplied by the power supply module and generates power to operate the electronic device 10.

At least one of the above-described components of the electronic device 10 may be included in the display device according to embodiments as described above. In addition, in terms of functionality, some of the individual modules included in one module may be included in the display device and others may be provided separately from the display device. For example, the display module 11 is included in the display device, whereas the processor 12, the memory 13, and the power module 14 are not included in the display device and are instead provided separately in the electronic device 10.

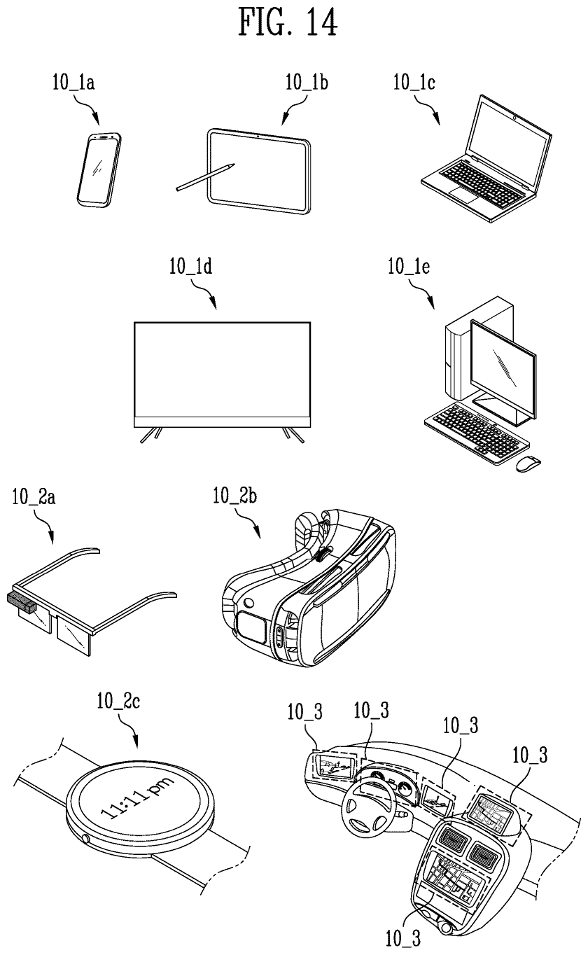

FIG. 14 shows schematic views of various embodiments of an electronic device.

Referring to FIG. 14, various types of electronic devices to which embodiments of a display device are applied may include an electronic device to display images such as a smartphone 10_1a, a tablet PC 10_1b, a laptop computer 10_1c, a television (TV) 10_1d, and a desktop monitor 10_1e, a wearable electronic device including a display module such as smart glasses 10_2a, a head-mounted display (HMD) 10_2b, and a smart watch 10_2c, and an automotive electronic device 10_3 including a display module such as a center information display (CID) disposed at the instrument cluster, the center fascia, and the dashboard of a vehicle, and a room mirror display.

Although the present disclosure has been described with reference to embodiments, a person skilled in the art will be able to understood that the present invention can be modified and changed in various ways within the scope of the ideas and areas of the present disclosure described in the appended claims, and their equivalents.

What is claimed is:

1. A pixel comprising:
a first power line configured to receive a first initialization power supply voltage configured to swing between a first voltage and a second voltage;
a light-emitting element;
a first circuit configured to control a supply period of a driving current in response to a data signal supplied from a data line; and
a second circuit configured to supply the driving current corresponding to a difference voltage of the first voltage and the second voltage to the light-emitting element.

2. The pixel according to claim 1, wherein the data signal has different voltages corresponding to different gradations.

3. The pixel according to claim 1, wherein the first circuit and the second circuit are electrically connected by a common node, and
the first circuit is configured to control the supply period of the driving current while controlling a voltage supplied to the common node according to the data signal.

4. The pixel according to claim 1, wherein the first circuit comprises:
a first transistor having a gate electrode connected to a first node, a first electrode connected to a second node, and a second electrode connected to a third node;
a second transistor connected between the data line and the second node and having a gate electrode connected to a scanning line;
a third transistor connected between the first node and the third node and having a gate electrode connected to the scanning line;
a fourth transistor connected between the first node and the first power line and having a gate electrode connected to a first initialization line; and
a first capacitor connected between a sweep line and the first node.

5. The pixel according to claim 4, wherein the first circuit further comprises:
a fifth transistor connected between a second power line configured to receive a first power supply voltage and the second node and having a gate electrode connected to a light-emitting control line; and
a sixth transistor connected between the third node and a fourth node and having a gate electrode connected to the light-emitting control line.

6. The pixel according to claim 5, wherein the first transistor, the fifth transistor, and the sixth transistor are P-type transistors, and
the second transistor, the third transistor, and the fourth transistor are N-type transistors.

7. The pixel according to claim 5, wherein the second circuit comprises:
a second capacitor connected between the fourth node and a fifth node;
a seventh transistor having a first electrode connected to a third power line configured to receive a second power supply voltage, a second electrode connected to a sixth node, and a gate electrode connected to the fifth node;
an eighth transistor connected between the fifth node and the sixth node and having a gate electrode connected to a compensation line;
a ninth transistor connected between the fourth node and the first power line and having a gate electrode connected to a second initialization line;
a tenth transistor connected between the sixth node and a first electrode of the light-emitting element and having a gate electrode connected to the light-emitting control line; and
an eleventh transistor connected between the fifth node and a fifth power line configured to receive a second initialization power supply voltage and having a gate electrode connected to a third initialization line, and
the second power supply voltage has a different voltage from the first power supply voltage.

8. The pixel according to claim 7, wherein the seventh transistor and the tenth transistor are P-type transistors, and
the eighth transistor, the ninth transistor, and the eleventh transistor are N-type transistors.

9. The pixel according to claim 7, wherein a second electrode of the light-emitting element is connected to a fourth power line configured to receive a third power supply voltage, and
the third power supply voltage has a lower voltage than the second power supply voltage.

10. The pixel according to claim 7, further comprising:
a twelfth transistor connected between the first electrode of the light-emitting element and a sixth power line configured to receive a third initialization power supply voltage and having a gate electrode connected to the control line,
wherein the twelfth transistor is a P-type transistor.

11. The pixel according to claim 7, further comprising:
a twelfth transistor which is connected between the first electrode of the light-emitting element and a sixth power line configured to receive a third initialization power supply voltage and having a gate electrode connected to the light-emitting control line,
wherein the twelfth transistor is an N-type transistor.

12. The pixel according to claim 7, further comprising a third capacitor connected between the third power line and the fifth node.

13. A display device comprising:
a first power line configured to receive a first initialization power supply voltage configured to swing between a first voltage and a second voltage; and
pixels connected to any one of scanning lines, any one of data lines, a first initialization line, a second initialization line, a third initialization line, a light-emitting control line, a compensation line, and a sweep line;
wherein each of the pixels comprises:
a light-emitting element;
a first circuit configured to control a supply period of a driving current in response to a data signal supplied from a data line from among the data lines connected to the pixel; and
a second circuit configured to supply the driving current corresponding to a difference voltage of the first voltage and the second voltage to the light-emitting element.

14. The display device according to claim 13, wherein the pixels are further connected to:
a second power line configured to receive a first power supply voltage;
a third power line configured to receive a second power supply voltage having a different voltage from the first power supply voltage;
a fourth power line configured to receive a third power supply having a lower voltage than the second power supply voltage;
a fifth power line configured to receive a second initialization power supply voltage; and
a sixth power line configured to receive a third initialization power supply voltage.

15. The display device according to claim 14, wherein the first circuit comprises:
a first transistor having a gate electrode connected to a first node, a first electrode connected to a second node, and a second electrode connected to a third node;
a second transistor connected between the data line and the second node and having a gate electrode connected to a scanning line;
a third transistor connected between the first node and the third node and having a gate electrode connected to the scanning line;
a fourth transistor connected between the first node and the first power line and having a gate electrode connected to the first initialization line;
a first capacitor connected between the sweep line and the first node;
a fifth transistor connected between the second power line and the second node and having a gate electrode connected to the light-emitting control line; and
a sixth transistor connected between the third node and a fourth node and having a gate electrode connected to the light-emitting control line.

16. The display device according to claim 15, wherein the second circuit comprises:
a second capacitor connected between the fourth node and a fifth node;
a seventh transistor having a first electrode connected to the third power line, a second electrode connected to a sixth node, and a gate electrode connected to the fifth node;
an eighth transistor connected between the fifth node and the sixth node and having a gate electrode connected to the compensation line;
a ninth transistor connected between the fourth node and the first power line and having a gate electrode connected to the second initialization line;
a tenth transistor connected between the sixth node and a first electrode of the light-emitting element and having a gate electrode connected to the light-emitting control line; and
an eleventh transistor connected between the fifth node and the fifth power line and having a gate electrode connected to the third initialization line.

17. The display device according to claim 16, wherein the first transistor, the fifth transistor, the sixth transistor, the seventh transistor, and the tenth transistor are P-type transistors, and
the second transistor, the third transistor, the fourth transistor, the eighth transistor, the ninth transistor, and the eleventh transistor are N-type transistors.

18. The display device according to claim 16, wherein the pixel further comprises a twelfth transistor connected between the first electrode of the light-emitting element and the sixth power line configured to receive the third initialization power supply voltage and having a gate electrode connected to the light-emitting control line or a control line configured to receive a control signal whose phase is inverted from that of a light-emitting control signal supplied to the light-emitting control line.

19. The display device according to claim 14, wherein one frame period comprises a first section, a second section, a third section, a fourth section, and a fifth section,
the display device further comprises:
a scanning driver configured to sequentially supply an enable scanning signal to the scanning lines during the second section;
a data driver configured to supply the data signal to the data lines during the second section;
a common driver configured to supply an enable first initialization signal to the first initialization line during the first section, an enable second initialization signal to the second initialization line during the third section and the fourth section, an enable third initialization signal to the third initialization line during the third section, an enable light-emitting control signal to the light-emitting control line during the fifth section, an enable compensation signal to the compensation line during a first sub-section which is a part of the fourth section, and the first initialization power supply voltage having the second voltage during the third section and the first sub-section and the first voltage during other periods to the first power line; and
a sweep driver configured to supply a sweep signal whose voltage is gradually lowered from a reference voltage to the sweep line during the fifth section.

20. An electronic device comprising:
a processor to provide image data signal; and
a display device to display an image based on the image data signal;
wherein the display device comprises:
a first power line configured to receive a first initialization power supply voltage configured to swing between a first voltage and a second voltage; and
pixels connected to any one of scanning lines, any one of data lines, a first initialization line, a second initialization line, a third initialization line, a light-emitting control line, a compensation line, and a sweep line;
wherein each of the pixels comprises:
a light-emitting element;
a first circuit configured to control a supply period of a driving current in response to a data signal supplied from a data line from among the data lines connected to the pixel; and
a second circuit configured to supply the driving current corresponding to a difference voltage of the first voltage and the second voltage to the light-emitting element.
